(19) United States
(12) Patent Application Publication
(10) Pub. No.: US 2026/0179403 A1
(43) Pub. Date: Jun. 25, 2026

(54) HANDHELD SCANNING APPARATUS

(71) Applicant: Empowering Tech Ltd., Seend (GB)

(72) Inventors: Toby Sutton, Seend (GB); Sachin Sachan, Mumbai (IN)

(21) Appl. No.: 19/426,036

(22) Filed: Dec. 18, 2025

(30) Foreign Application Priority Data
Dec. 20, 2024 (GB) 2418796.5

(51) Int. Cl. G06V 30/142; G06T 7/73

(52) U.S. Cl. CPC G06V 30/142; G06T 7/73

(57) ABSTRACT

A handheld scanning apparatus 10 for scanning text and converting the text into a different format, the handheld apparatus comprising a body 12, a camera 25 arranged in the body 12 and configured, in use, to capture images of text, the apparatus 10 configured to determine, for a captured image containing text, a position of a text upper boundary or a text lower boundary, and compare the position of the text upper boundary or the text lower boundary with pre-defined criteria, the apparatus 10 further comprising an indicator configured to provide an indication that the position of the text upper boundary or the text lower boundary meets or does not meet the pre-defined criteria. In this way, a user is provided with an indication as to whether or not they are holding or moving the scanner in an optimal manner for the apparatus to correctly recognise text.

### CROSS-REFERENCE TO RELATED APPLICATIONS

This application claim priority to British Application No. GB2418796.5 filed Dec. 20, 2024, which is hereby incorporated by reference in its entirety.

### BACKGROUND OF THE INVENTION

The present invention relates generally to a handheld scanning apparatus and a method of scanning text and finds particular, although not exclusive, utility in scanning text and converting it into an audible signal.

Handheld scanners comprising cameras are known. In use, such a handheld scanner is moved over a surface and the camera captures images of each part of the surface as it moves over it. The captured images may then be combined to reconstruct a complete image of the surface, manipulated and/or reproduced in some other way, or analysed for particular features. For example, where a captured image contains text, known text recognition procedures may be carried out on the captured image to produce an audible signal which reads the text to a user.

In order for text to be recognisable within an image, both the top and bottom of the text should ideally be within the image, or within a particular region of interest within the image. For example, when the scanner is being used to scan a line of text on a page, it ideally needs to be moved relative to the page in a direction substantially parallel to the line of text, so that the top and bottom of the line of text remain within the region of interest in each image captured by the camera as the scanner is moved.

However, a user may hold or move the scanner relative to a surface in such a way that the camera captures images in which the top and/or bottom of text on the surface are not within the region of interest (e.g. by moving the scanner along a curved trajectory, or in a direction non-parallel to a line of text). This may result in the scanned text being entirely unrecognisable, only partially recognisable, or in some cases, being incorrectly recognised.

Accordingly, there is a need for a hand-held scanning apparatus that addresses this problem.

### SUMMARY OF THE INVENTION

In a first aspect, the present invention provides a handheld scanning apparatus for scanning text and converting the text into a different format, the handheld apparatus comprising a body, a camera arranged in the body and configured, in use, to capture images of text, the apparatus configured to determine, for a captured image containing text, a position of a text upper boundary or a text lower boundary, and compare the position of the text upper boundary or the text lower boundary with pre-defined criteria, the apparatus further comprising an indicator configured to provide an indication that the position of the text upper boundary or the text lower boundary meets or does not meet the pre-defined criteria.

The pre-defined criteria may relate to the location of the text within the field of view of the camera, as described in further detail below. In this way, a user is provided with an indication as to whether or not they are holding or moving the scanner in an optimal manner for the apparatus to correctly recognise text. The user may adjust the position of the scanner in response to the indication and thereby ensure that the text remains recognisable throughout the scanning process.

Converting scanned images into a different format may involve manipulating, processing and/or encoding the scanned images to produce an output that is different to the original image captured by the camera. For example, where an image contains text, converting the image into a different format may involve generating an audio output signal based on the text; converting the image into a string of text; and/or generating a new image in which the text has been translated into a different language.

The apparatus may be configured to determine the positions of both the upper text boundary and the lower text boundary and compare the positions of both the upper text boundary and the lower text boundary with the pre-defined criteria.

The text upper boundary may comprise an imaginary line or contour within the image. The apparatus may define the text upper boundary by analysing the image. It is to be understood that the image may comprise an array of pixels. In the following discussion, the term “text pixel” is used to denote a pixel containing a part of a text character (e.g. a black pixel in a black and white image of black text on a white background), and “background pixel” is used to denote a pixel not containing part of a text character (e.g. a white pixel in the above black and white image).

In order to determine the position of the text upper or lower boundary, the apparatus may first identify regions of the image containing individual characters or words (referred to herein as “character segments” and “word segments”, respectively). Dividing the image into character or word segments may involve identifying the text itself (e.g. using pattern, shape and/or optical character recognition), identifying the blank spaces around characters or words (e.g. using pixel values) and/or using any known character segmentation methods.

The apparatus may then identify a “highest point” of the character or word within each segment. The highest point may be measured in a reference frame of the image. The reference frame of the image may be a 2-dimensional reference frame, described by a co-ordinate system having orthogonal x-and y-axes, with the x-axis parallel to rows of pixels and the y-axis parallel to columns of pixels. Identifying the highest point may involve finding the text pixel(s), within the segment, with the greatest value of y-coordinate.

The apparatus may define the text upper boundary as a contour connecting the highest points of each character or word. Alternatively, the apparatus may define the text upper boundary as a straight line contour based on the highest points. This may involve finding a “line of best fit” for each of the highest points, using any known line fitting method or algorithm. In finding such a line of best fit, a constraint may be placed on either or both of the gradient of the line and a point though which the line passes. For example, the line may be constrained so that it passes through the overall highest point out of all the highest points (i.e. the highest point having the greatest value of y-coordinate in the reference frame of the image), or so that it is approximately parallel (e.g. within ±5 degrees) to a baseline of the text. As used herein, the term “baseline” is given its typographical meaning. That is: an imaginary line upon which characters that do not have descenders sit, and below which descenders descend.

The text upper boundary may be taken to be the line of best fit, or the line of best fit may be displaced upwards (i.e. in the positive y-direction), for example by 2, 5, 7, 10 or more pixels. Alternatively, the apparatus may not find a line of best fit at all and may define the text upper boundary as a straight line contour found by fixing a point through which the contour must pass (e.g. the overall highest point) and the gradient of the line (e.g. to be parallel with the baseline).

The apparatus identifying the highest and/or lowest points of characters or words may involve the apparatus identifying boundaries between text pixels and background pixels by looking for step changes in the pixel values. For example, the apparatus may convert the image, to grayscale and identify regions of pixels in which the absolute value of the local grayscale gradient (i.e. the rate of change of grayscale value along a line connecting adjacent pixels) exceeds a certain value. Alternatively, in an RGB colour image, the apparatus may identify regions of pixels in which the absolute value of the local gradient (i.e. rate of change of value along a straight line connecting adjacent pixels) in one or more of the R, G or B channels exceeds a certain value. However, it is to understood that any known edge detection technique may be additionally or alternatively used for this purpose.

The apparatus may define the text upper boundary without first identifying character or word segments. For example, the above-described boundary detection method, based on changes in pixel value, may be used to find a “highest” text pixel in each column of pixels in the image. The apparatus may then define the text upper boundary as a contour connecting all of, or a subset of, these highest pixels, or as a straight line contour based on the highest points, or a subset thereof, e.g. as described above with reference to the highest points of characters or words.

The text lower boundary may comprise another imaginary line or contour within the image. The apparatus may define the text lower boundary in a similar way to the text upper boundary, with appropriate changes from “upper” to “lower” and “highest” to “lowest”.

The image may comprise a zone of interest having a zone of interest upper boundary and a zone of interest lower boundary, and the pre-defined criteria may include the requirement that the text upper boundary does not meet, intersect or lie outside the zone of interest upper boundary, and/or the requirement that the text lower boundary does not meet, intersect or lie outside the zone of interest lower boundary.

For example, the zone of interest may be a region of the image, captured by the camera, on which text recognition is to be carried out, or which is to be displayed to a user, manipulated or processed in some way. The zone of interest may comprise a predetermined subset of pixels within the image. For example, the zone of interest may comprise a pre-defined area of the image such that a margin between the zone of interest and the edges of the image is formed around the entire perimeter of the zone of interest. In this way, artefacts formed close to the edges of the image, for instance by the camera lens, may be excluded from the zone of interest.

Alternatively, the zone of interest may extend across the entire width of the image. That is, no margin may be present between the zone of interest and a left hand or right hand edge of the image.

The zone of interest may cover at least 50% of the image; in particular, at least 75% of the image; more particularly, at least 90% of the image. The zone of interest may be the entirety of the image.

The zone of interest may be rectangular in shape. The zone of interest upper boundary may then be an upper edge of the rectangle and the zone of interest lower boundary may be a lower edge of the rectangle. Alternatively, the zone of interest may have a different shape, such as a circle, ellipse, trapezium, parallelogram, hexagon or octagon. In such cases, the zone of interest upper boundary may be an upper portion of the perimeter of the zone of interest and the zone of interest lower boundary may be a lower portion of the perimeter of the zone of interest.

Alternatively, or additionally, where the text upper boundary is defined as a straight line contour, the pre-defined criteria may include the requirement that the text upper boundary is approximately parallel to the zone of interest upper boundary. Similarly, where the text lower boundary is defined as a straight line contour, the pre-defined criteria may include the requirement that the text lower boundary is approximately parallel to the zone of interest lower boundary. Approximately parallel may mean within ±30 degrees of being parallel; in particular, within ±20 degrees of being parallel; more particularly, within ±15 degrees of being parallel; more particularly still, within ±10 degrees of being parallel. For example, if the angle between the text upper boundary and the zone of interest upper boundary is greater than 30 degrees, the pre-defined criteria may not be met.

Additionally, or alternatively, the pre-defined criteria may include criteria relating to the rate at which the position of the text upper boundary, relative to the zone of interest upper boundary, and/or the position of the text lower boundary, relative to the zone of interest lower boundary, changes between a first image and a second, subsequently captured image. For example, the pre-defined criteria may include a requirement that the minimum vertical distance between the text upper boundary and the zone of interest upper boundary does not decrease by more than a predetermined threshold number of pixels between the first and second images.

In this way, the pre-defined criteria may not be met if the user moves the apparatus in such a way that the text upper or lower boundary gets closer to the zone of interest upper or lower boundary respectively, before the text upper or lower boundary actually meets the zone of interest upper or lower boundary. Consequently, the apparatus may provide the user with an early warning, giving them a chance to correct the way in which they are moving the apparatus before the scanned text becomes unrecognisable.

Alternatively, or additionally, the pre-defined criteria may include a requirement that the angle between the text upper boundary and the zone of interest upper boundary does not increase by more than a predetermined threshold angle between the first and second images.

In this way, the pre-defined criteria may not be met if the user starts “veering off”, away from the horizontal, for example if they move the apparatus on a curved trajectory across the page. The apparatus may then provide the user with an early warning, giving them a chance to correct the way in which they are moving the apparatus before the scanned text becomes unrecognisable.

The apparatus may be configured to determine whether the image contains more than one line of text and, in response to determining that the image contains more than one line of text, to select a single line of text for which to determine a text upper boundary or a text lower boundary.

Determining whether the image contains more than one line of text may involve carrying out pattern recognition and/or optical character recognition to identify lines of text within the image.

In this way, the apparatus may be prevented from providing indications relating to the position of the text upper boundary or the text lower boundary of lines of text that are not preferably being scanned (e.g. lines of text immediately above or below a line of text being scanned) that might otherwise irritate and/or confuse a user.

The selected single line of text may be the line of text that is closest to a pre-defined reference line on the image.

For example, the selected single line of text may be the line of text that is closest, on average, to a centre line of the image or a centre line of the zone of interest. In this context, a centre line may be a line that is equidistant from the top and bottom edges of the image or zone of interest at all points along its length.

The apparatus may be configured to select the single line of text based on a comparison of the image with an earlier image captured by the camera.

For example, if a single line of text has been selected in the earlier image, the apparatus may be configured to compare the (current) image with the earlier image and to select the line of text that has a position within the image closest to the position that the selected line of text in the earlier image had within that earlier image.

The apparatus may select a line of text in this way by determining the respective positions of the selected line of text in the earlier image and any identified lines of text in the (current) image (e.g. by reference to rectangular regions assigned therearound, or baselines, as described above). The apparatus may then find the line of text having a position in the image that is a closest match to the position of the selected line in the earlier image. For example, the apparatus may calculate a value of a “penalty function” for each identified line of text in the image, based on the displacement of the line of text in the y-direction relative to the position of the selected line of text in the earlier image, and may then select the line of text for which the value of the penalty function is lowest.

Alternatively, or additionally, the apparatus may carry out optical character recognition on both the image and the earlier image and select the line of text in the image by identifying a portion of the selected line of text in the previous image that is present in the (current) image. For example, the apparatus may identify that a line of text in the image includes a string of characters that were included in the selected line of text in the earlier image and, as a result, may select this line of text. As a specific example, if the selected line of text in the earlier image contains the characters “WHAT IS TH” and the current image includes a line of text containing the characters “T IS THE TIME”, the apparatus may recognise that the first six characters (including spaces) in this line of text are identical to the last six characters in the selected line of text in the earlier image, and may select the line of text in the current image on this basis.

In this way, the apparatus may track a single line of text through a series of images and provide an indication when the text upper or lower boundary of the line of text does not meet the pre-defined criteria, even if the upper and lower boundaries of another (unselected) line of text meet the pre-defined criteria. This ensures that the user receives an indication that is relevant to the line of text that they are scanning.

The apparatus may comprise a processor configured to carry out any of the steps discussed above, such as to recognise characters or words; carry out character segmentation; calculate pixel value gradients; identify highest or lowest points; calculate equations of lines; define text upper or lower boundaries; define the zone of interest; define the pre-defined criteria; and/or compare the position of the text upper boundary or the text lower boundary with the predefined criteria. Alternatively, the apparatus may carry out these steps by communicating with a remote processor (i.e. separate from the apparatus).

The processor, or a remote processor, may additionally pre-process the images captured by the camera in order to identify the text more accurately. Pre-processing the images may involve de-skewing, resizing, cropping, recolouring, desaturating, sharpening, de-speckling, adjusting the contrast of, or carrying out any similar corrections on the images. Alternatively, or additionally, pre-processing the images may involve combining (e.g. stitching together) multiple images.

The indicator may be configured to provide an indication in the form of one or more of a haptic, audio and visual manner.

For example, the indicator may comprise one or more of a buzzer, a loudspeaker, a vibrator (e.g. an eccentric rotating mass motor), an LED and a lamp. The indicator may be configured to provide an indication in a first manner when the text upper or lower boundary meets the pre-defined criteria, and an indication in a second manner when the text upper or lower boundary does not meet the pre-defined criteria. Alternatively, the indicator may be configured to only give an indication when either the text upper or lower boundary meets the pre-defined criteria or the text upper or lower boundary does not meet the pre-defined criteria. That is, a lack of an indication from the indicator may, in itself, be an indication.

The indication that the text upper boundary meets or does not meet the pre-defined criteria may be different to the indication that the text lower boundary is meets or does not meet the pre-defined criteria.

In this way, the user is presented with a clear indication as to which way they need to adjust the position of the apparatus (i.e. “up” or “down” the page/surface being scanned) in order to ensure that the scanned text is recognisable.

For example, the indicator may provide an indication in a first manner that the text upper boundary meets or does not meet the pre-defined criteria, and may provide an indication in a second manner that the lower text boundary meets or does not meet the pre-defined criteria. Alternatively, different indications in the same manner may be used, such as LEDs in different colours, different buzzer tones or vibrations in different parts of the apparatus.

The apparatus may further comprise a display screen configured to display at least a portion of the image captured by the camera.

The portion of the image captured by the camera may be, for example, the part of the image within the zone of interest, or the entire image received from the camera. Additionally, or alternatively, the display screen may be configured to display information about such images, such as text recognised in the image.

The display screen may also be used to display an indication that the text upper or lower boundary meets or does not meet the pre-defined criteria. For example, the display screen may display a visual flag, warning symbol or icon if the text upper boundary or text lower boundary does not meet the pre-defined criteria. In one particular example, the display screen may display an “up arrow” if the text lower boundary does not meet the pre-defined criteria (i.e. so that the user needs to move the apparatus up the page/surface being scanned), and a “down arrow” if the text upper boundary does not meet the pre-defined criteria (i.e. so that the user needs to move the apparatus down the page/surface to be scanned). Alternatively, the display screen may display text indicating that the text upper boundary or text lower boundary meets or does not meet the pre-defined criteria.

The apparatus may be configured to continuously capture images with the camera, as the apparatus is moved across a surface in use, and to determine a position of a respective text upper boundary or a respective text lower boundary for each captured image; to compare the position of the respective text upper boundary or the respective text lower boundary with pre-defined criteria; and to provide an indication that the position of the respective text upper boundary or the respective text lower boundary meets or does not meet the pre-defined criteria.

Continuously capturing images may involve capturing a series of images in rapid succession. The series of images may be captured at a frame rate of more than 1 frame per second (fps); in particular, more than 10 fps; more particularly, more than 20 fps; for example, 30 fps.

In a second aspect, the invention provides a method of scanning text and converting the text into a different format, the method comprising the steps of: providing the apparatus according to the first aspect; moving the apparatus across a surface containing text; capturing images of the text with the camera; the apparatus determining, for at least some of the captured images containing text, the position of a text upper boundary or a text lower boundary; the apparatus comparing the position of the text upper boundary or the text lower boundary with pre-defined criteria; and the apparatus providing an indication that the position of the text upper boundary or the text lower boundary meets or does not meet the pre-defined criteria.

It is to be appreciated that, in the above discussion, the terms “upper”, “lower”, “up”, “down”, “top”, “bottom”, “left” and “right” are used with regard to a 2-dimensional reference frame of an image captured by the camera. These terms may not be interpreted as being descriptive of relative positions in the 3-dimensional reference frame of a user.

### BRIEF DESCRIPTION OF THE SEVERAL VIEWS OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a perspective view of a handheld scanning apparatus;

FIG. 2 is a block diagram of how the apparatus may operate;

FIG. 3 is a schematic view of a first image captured by the camera, showing a line of text being selected;

FIG. 4 is a schematic view of a second image captured by the camera, showing a line of text being selected;

FIG. 5 is schematic view illustrating a step of determining text upper and lower boundaries;

FIG. 6 is a schematic view of a third image captured by the camera, including a line of text that meets the pre-defined criteria; and

FIG. 7 is a schematic view of a fourth image captured by the camera, including a line of text that does not meet the pre-defined criteria.

### DETAILED DESCRIPTION OF THE INVENTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

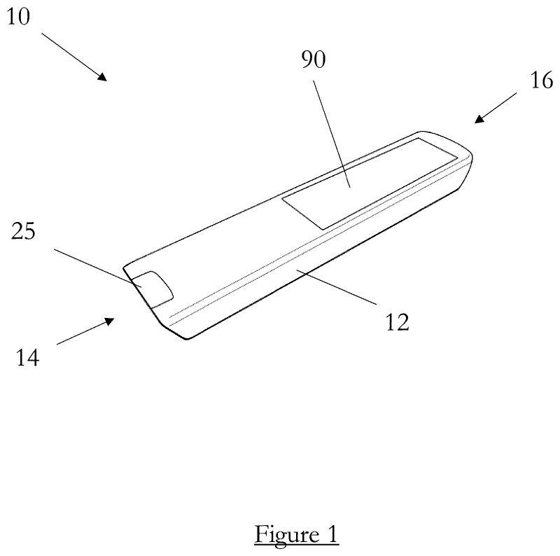

FIG. 1 is a perspective view of a handheld scanning apparatus 10. The handheld scanning apparatus 10 comprises a generally cuboid body 12 configured to be held easily and comfortably in the hand of a user. The body 12 is elongate in shape, extending from a first end 14 to a second end 16 such that the body 12 has a length as measured between the first end 14 and the second end 16 that is substantially greater than a width of the body 12 measured in any direction perpendicular to the length. The body may have a length of around 15 cm.

In use, the user holds the body 12 in their hand with the first end 14 of the body 12 closely adjacent, or in contact with, a surface comprising text to be scanned, such as a page of a book. They then move the body 12 across the surface, keeping the first end 14 closely adjacent or in contact with the surface. A digital camera 25 is arranged in the first end 14 of the body 12 and captures a series of images of the surface as the body 12 is moved across the surface.

The captured images may then be processed (e.g. by a processor) and an output signal provided to the user. For example, the output signal may comprise an audio output so that the apparatus 10 effectively “reads” the text out loud to the user. Alternatively, or additionally, the output signal may comprise a graphic display that displays the text in a way that is easier for the user to read (e.g. magnified, or with a tinted background). In another example, the text being scanned may be in a first language and the output signal may comprise an audio and/or graphic output of a translation of the text into a second language.

Processing the captured images may involve stitching the images together to form a larger image (such as a complete word), or processing each image individually. Processing the captured images may involve carrying out optical character recognition to identify text in the captured images. The processing of the captured images may be carried out by a processor within the body 12 or by a remote processor (i.e. outside of the body 12).

The apparatus 10 shown in FIG. 1 comprises a display screen 90, which may comprise an LED display, an LCD display, an OLED display or any similar type of display. The display screen may be used to provide a graphical output relating to the image scanned by the camera, as described above. Alternatively, or additionally, the display screen 90 may comprise a touch screen and may display menus and/or touch-sensitive controls for setting up and/or operating the handheld scanning apparatus 10.

In order for the apparatus to provide a useful or meaningful output, each image captured by the camera 25 should ideally include the full height of the text being scanned (i.e. characters should not be clipped at the top or bottom). It is therefore important that the user moves the body 12 over the surface in a direction approximately parallel to a line of text on the surface. If they move the body 12 over the surface in a substantially different direction (e.g. at an angle of more than 5 degrees relative to the direction of the text), the first image or first few images may contain the full height of the text, but later images may exclude parts of the text which are now outside the field of view of the camera, such that the text may not be accurately recognised. Furthermore, where the surface comprises multiple lines of text, although the first few images may include text from a first line, later images may include text from a line above or below the first line, thereby leading to the user being provided with a nonsensical output.

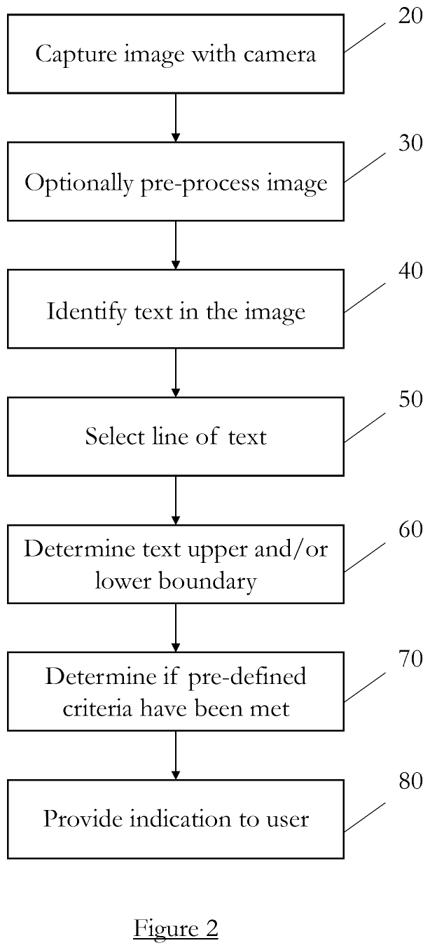

With reference to FIG. 2, in order to aid the user in moving the body 12 across a surface in an optimal way, the apparatus 10 is configured to analyse the content of the images captured by the camera 25 and provide an indication to the user as to whether or not the text is located optimally within the image. The apparatus 10 may be configured to analyse each image captured by the camera or to only analyse a subset of the images, for example every other image or every third image.

As shown in FIG. 2, after an initial step 20 of capturing images using the camera 25, the apparatus 10 may optionally carry out a pre-processing step 30, in which the captured images are pre-processed. Pre-processing the image may involve, for example, cropping, resizing, recolouring and/or sharpening the image.

The apparatus then carries out a pattern/character recognition step 40, in which lines of text, words and/or characters are recognised within the pre-processed image (or the “raw” images from the camera 25 where pre-processing step 30 is excluded).

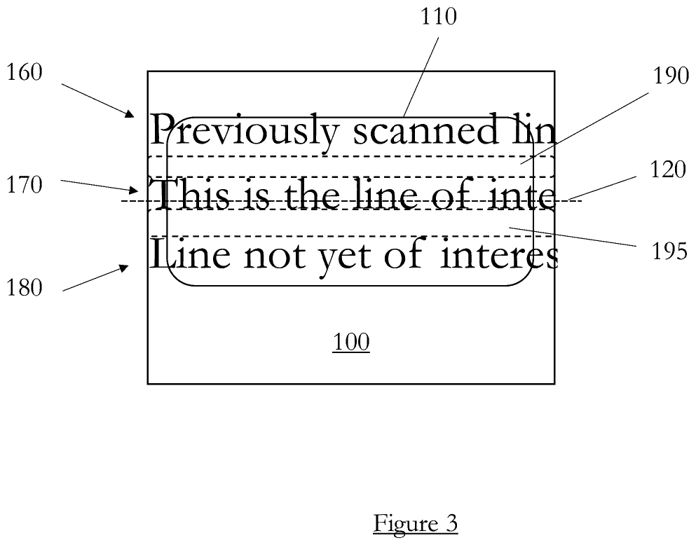

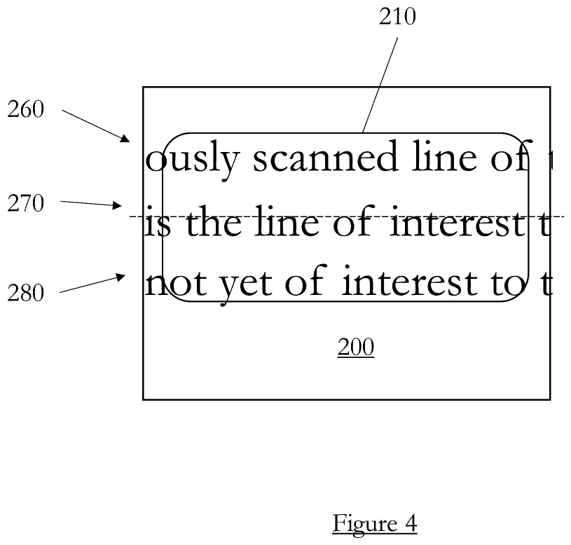

Next, the apparatus carries out a line selection step 50 to identify whether or not the image contains more than one line of text. If more than one line of text is identified, the apparatus selects a single line of text to follow (as shown in FIGS. 3 and 4).

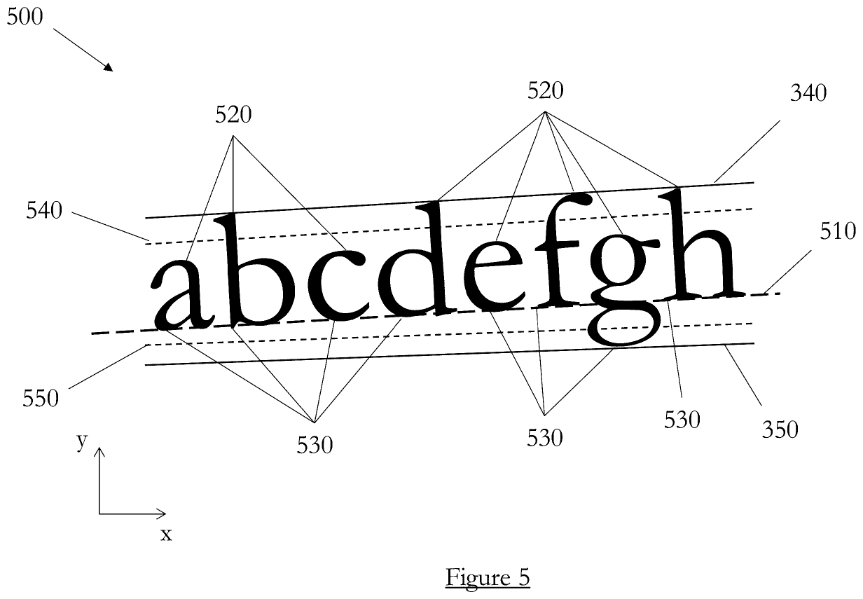

A text upper/lower boundary determination step 60 follows, in which the location of a text upper boundary and/or a text lower boundary of the selected line of text is determined (as shown in FIG. 5).

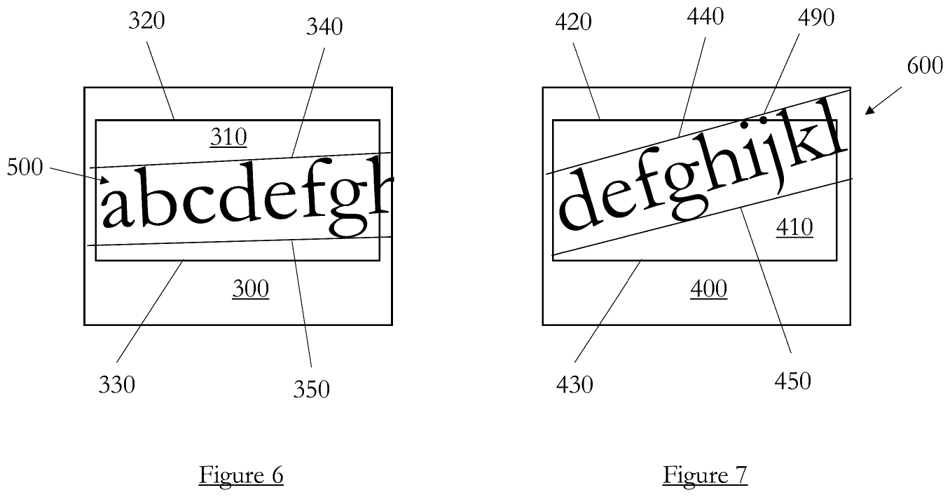

The apparatus then carries out a step 70 of comparing the determined location of the text upper boundary and/or text lower boundary with pre-defined criteria (see FIGS. 6 and 7), and provides an indication 80 to the user of the result of that comparison. The indication 80 may be provided to the user graphically on the display screen 90 and/or using one or more additional indicators, such as an LED, a buzzer or a haptic transducer (e.g. vibrator motor).

The apparatus 10 may comprise additional components such as a battery, a light source, such as an LED, configured to illuminate a region of the surface immediately adjacent the first end 14 of the body 12 and/or a communication means to facilitate communication between the body 12 and a remote processor or other electronic devices, such as digital memory.

FIG. 3 shows a first image 100 captured by the camera, illustrating how the apparatus may select a line of text. The first image 100 is depicted as being rectangular and in a landscape orientation; however, it is to be appreciated that the images captured by the camera may have a different shape and/or orientation. The first image 100 may be the first image captured by the camera when the user starts scanning a new page or a new line of text. The first image 100 comprises a zone of interest 110. In this example, the apparatus has defined the zone of interest 110 as an area of the image 100 excluding a border around the edges, so that any artefacts, blurring or distortion occurring near the edges of the image may be ignored. That is, the zone of interest 110 is an approximately rectangular region towards the centre of the image 100. However, the zone of interest may take any shape and may be located anywhere within the image, and in some cases may be the entire image. A centre line of the zone of interest is shown as a dashed horizontal line 120, parallel to and equidistant from the upper and lower edges of the zone of interest 110.

The first image 100 includes parts of three lines of text 160, 170, 180, oriented horizontally and approximately parallel to the centre line 120, with one line of text at the top, one in the middle and one at the bottom. In this Figure, the line in the middle 170 is the line of interest to the user. The apparatus has determined the respective positions of these three lines of text on the first image 100, for example by identifying a first region of blank space 190 (indicated by a broken outline) separating the top line 160 and the middle line 170, and a second region of blank space 195 between the middle line 170 and the bottom line 180.

The apparatus next determines which of the three lines 160, 170 and 180 is positioned, closest to the centre line 120. For example, the apparatus may be arranged to calculate a value of a “cost function”, indicative of the distance of a line of text from the centre line 120, for each of the lines 160, 170, 180, the cost function increasing with distance from the centre line 120. The apparatus may be arranged to select the line of text for which the cost function has the lowest value. The cost function may be a function of the distance between a highest point in a line of text and the upper edge of the image 100 or zone of interest 110; the distance between a lowest point in a line of text and the lower edge of the image 100 or zone of interest 110; and/or the distance between a midpoint of a line of text and the centre line 120. In this case, the closest line of text to the centre line 120 is the middle line 170 and so the apparatus selects this line and ignores the top line 160 and the bottom line 180.

FIG. 4 shows a second image 200 captured by the camera shortly after the first image 100. As can be seen, between the camera capturing the first image 100 and the second image 200, the user has moved the apparatus over the page, approximately parallel to the direction of the text but slightly up the page, such that the text in the second image 200 is still at the same orientation but is shifted to the left and slightly downwards, relative to its position in the first image 100. The second image 200 also comprises a zone of interest 210, located within the second image 200 in the same way as the zone of interest 110 is located within the first image 100.

The apparatus once again determines, in the same way as before, the positions of the three lines of text 260, 270 and 280 within the second image 200. Then, instead of comparing the positions of the lines of text 260, 270, 280 with a centre line, the apparatus determines which of the three lines of text 260, 270, 280 is a continuation of the selected line of text 170 in the first image. It may do this, for example, by calculating the vertical displacement of each of the three lines of text 260, 270, 280 relative to the position of the selected line of text 170 in the first image 100, and selecting the line of text for which this vertical displacement is smallest, which in this case is the middle line 270.

However, it is to be appreciated that the apparatus may select the middle line of text 270 in a different way. For example, the apparatus may carry out pattern, or character, recognition on the text in the first and second images and determine that the middle line 270 in the second image 200 is a continuation of the selected line 170 in the first image 100 by recognising that the characters “is the line of inte” at the start of the middle line 270 are the same as the characters at the end of the selected line 170 in the first image 100.

FIG. 5 shows a simple example of how the text upper and lower boundary may be determined. In this example, a line of text 500 comprises the letters “abcdefgh”. It can be assumed that the text 500 forms part of a third image and that the third image has not been rotated (i.e. the image x-axis is horizontal and the y-axis is vertical, as indicated). It is to be understood that the term “third” is used here merely to distinguish the third image from the first and second images depicted in FIGS. 3 and 4 respectively, and not to be descriptive of any sort of relationship between the third image and the first and second images. A baseline 510, upon which the letters sit, except for the letter “g”, is shown for illustrative purposes. As can be seen, the baseline is almost horizontal, with a slight upward slant (as scanned from left to right).

The apparatus has separated the text 500 into individual letters (e.g. using pattern, or character, recognition, or detecting the gaps therebetween) and, for each letter, determined a highest point 520 in the reference frame of the image (i.e. the point for which the value of the y-coordinate is greatest). An upper straight line 540 has been fitted to these points (e.g. using a line fitting algorithm). Similarly, the apparatus has determined a lowest point 530 of each letter (i.e. the point for which the value of the y-coordinate is lowest) and has fitted a lower straight line 550 to these points. The apparatus has then defined a text upper boundary 340 as a third straight line obtained by translating the upper line 540 upwards (i.e. in the positive y-direction) so that it passes through the overall highest point of the entire text 500, which, due to the slight upward slant of the text 500 is the top of the letter “h”. Similarly, the apparatus has defined a text lower boundary 350 as a fourth straight line obtained by translating the lower line 550 downwards (i.e. in the negative y-direction) so that it passes through the overall lowest point of the entire text 500, which is the bottom of the letter “g”.

FIG. 6 shows the whole of the third image 300, including the text 500. The third image 300 comprises a zone of interest 310, which is once again approximately rectangular and located towards the centre of the third image 100. An upper edge of the zone of interest forms a zone of interest upper boundary 320 and a lower edge of the zone of interest forms a zone of interest lower boundary 330.

The text 500 is positioned within the image 300 such that text upper boundary 340 lies fully below the zone of interest upper boundary 320 without meeting or intersecting it at any point. Similarly, the text lower boundary 350 lies fully above the zone of interest lower boundary 330 without meeting or intersecting it at any point. This scenario may correspond to the text upper and lower boundaries meeting the pre-defined criteria

The apparatus may determine that the text upper boundary 340 meets the pre-defined criteria by, for example, formulating equations for the text upper boundary 340 and the zone of interest upper boundary 320 and determining that there is no intersection between these boundaries within the image 300, and that the text upper boundary 340 lies below the zone of interest upper boundary 320. Similarly, the apparatus may determine that the text lower boundary meets the pre-defined criteria by formulating equations for the text lower boundary 350 and the zone of interest lower boundary 330 and determining that there is no intersection between these boundaries within the image, and that the text lower boundary 350 lies above the zone of interest upper boundary 330. Alternatively, or additionally, the apparatus may superimpose the zone of interest upper boundary 320, the zone of interest lower boundary 330, the text upper boundary 340 and the text lower boundary 350 on the image and graphically recognise (e.g. using feature extraction) that the lines do not intersect, and that the lines representing the text upper and lower boundaries 340, 350 lie between the lines representing the zone of interest upper and lower boundaries 320, 330.

The apparatus may then provide an indication to the user that the text is positioned in such a way that the pre-defined criteria have been met.

FIG. 7 shows a fourth image 400 captured by the camera shortly after the third image 300. As can be seen, the user has moved the body of the scanner along the line of text but has started to deviate from the optimal scanning direction so that the text 600 in the image 400 is oriented at an angle substantially greater than 15 degrees, measured relative to the upper and lower edges of the image 400.

The fourth image 400 comprises a zone of interest 410 having a zone of interest upper boundary 420 and a zone of interest lower boundary 430, located within the fourth image 400 in the same way as the zone of interest 310 is located within the third image 300 in FIG. 6.

As can be seen in FIG. 7, the letters “defghi” appear entirely within the zone of interest 410, but the letters “jkl” cross the zone of interest upper boundary 420 so that the tops of these letters are outside the zone of interest 410. Consequently, the apparatus may not be able to accurately recognise these letters. The apparatus may determine that part of the text is outside the zone of interest 410 by defining a text upper boundary 440 and a text lower boundary 450 (in the same way as described with reference to FIG. 5) and determining that a point of intersection 490 exists between the text upper boundary 440 and the zone of interest upper boundary 420.

The apparatus may determine that there is a point of intersection 490 of the text upper boundary 440 and the zone of interest upper boundary 420 by formulating equations for these two boundaries within the image 400. Alternatively, or additionally, the apparatus may superimpose the zone of interest upper boundary 420, and text upper boundary 440 on the image and graphically recognise the point of intersection 490.

The apparatus may then provide an indication to the user that the pre-defined criteria are no longer met. This indication may comprise an indication that it is the text upper boundary 440 that does not meet the predefined criteria, rather than the text lower boundary 450, so that the user is prompted to make the appropriate corrective action (i.e. move the body of the apparatus “upwards” rather than “downwards”).

What is claimed is:

1. A handheld scanning apparatus for scanning text and converting the text into a different format, the handheld apparatus comprising:
a body,
a camera arranged in the body and configured, in use, to capture images of text,
the apparatus configured to determine, for a captured image containing text, a position of a text upper boundary or a text lower boundary, and compare the position of the text upper boundary or the text lower boundary with pre-defined criteria,
the apparatus further comprising an indicator configured to provide an indication that the position of the text upper boundary or the text lower boundary meets or does not meet the pre-defined criteria.

2. The handheld scanning apparatus according to claim 1, wherein the apparatus is configured to determine the positions of both the upper text boundary and the lower text boundary and compare the positions of both the upper text boundary and the lower text boundary with the pre-defined criteria.

3. The handheld scanning apparatus according to claim 1, wherein the image comprises a zone of interest having a zone of interest upper boundary and a zone of interest lower boundary, and wherein the pre-defined criteria include the requirement that the text upper boundary does not meet, intersect or lie outside the zone of interest upper boundary, and/or the requirement that the text lower boundary does not meet, intersect or lie outside the zone of interest lower boundary.

4. The handheld scanning apparatus according to claim 3, wherein the zone of interest is the entirety of the image.

5. The handheld scanning apparatus according to claim 1, wherein the apparatus is configured to determine whether the image contains more than one line of text and, in response to determining that the image contains more than one line of text, to select a single line of text for which to determine a text upper boundary or a text lower boundary.

6. The handheld scanning apparatus according to claim 5, wherein the selected single line of text is the line of text that is closest to a pre-defined reference line on the image.

7. The handheld scanning apparatus according to claim 5, wherein the apparatus is configured to select the single line of text based on a comparison of the image with an earlier image captured by the camera.

8. The handheld scanning apparatus according to claim 1, wherein the indicator is configured to provide an indication in the form of one or more of a haptic, audio and visual manner.

9. The handheld scanning apparatus according to claim 1, wherein the indication that the text upper boundary meets or does not meet the pre-defined criteria is different to the indication that the text lower boundary meets or does not meet the pre-defined criteria.

10. The handheld scanning apparatus according to claim 1, further comprising a processor configured to process the images captured by the camera to determine the position of the text upper boundary or the text lower boundary and compare the position of the text upper boundary or the text lower boundary with the pre-defined criteria.

11. The handheld scanning apparatus according to claim 1, further comprising a display screen configured to display at least a portion of the image captured by the camera.

12. The handheld scanning apparatus according to claim 1, wherein the apparatus is configured to continuously capture images with the camera, as the apparatus is moved across a surface in use, and to determine a position of a respective text upper boundary or a respective text lower boundary for each captured image; to compare the position of the respective text upper boundary or the respective text lower boundary with pre-defined criteria; and to provide an indication that the position of the respective text upper boundary or the respective text lower boundary meets or does not meet the pre-defined criteria.

13. A method of scanning text and converting the text into a different format, the method comprising the steps of: providing the apparatus according to claim 1; moving the apparatus across a surface containing text; capturing images of the text with the camera; the apparatus determining, for at least some of the captured images containing text, the position of a text upper boundary or a text lower boundary; the apparatus comparing the position of the text upper boundary or the text lower boundary with pre-defined criteria; and the apparatus providing an indication that the position of the text upper boundary or the text lower boundary meets or does not meet the pre-defined criteria.
